(19) United States
(12) Patent Application Publication
(10) Pub. No.: US 2019/0323486 A1
(43) Pub. Date: Oct. 24, 2019

(54) Modular Wind Turbine

(71) Applicant: aerodyn consulting Singapore pte ltd, Singapore (SG)

(72) Inventor: Sonke SIEGFRIEDSEN, Rendsburg (DE)

(21) Appl. No.: 16/309,315

(22) PCT Filed: Apr. 28, 2017
(86) PCT No.: PCT/DE2017/100356

§ 371 Date: Dec. 12, 2018

(30) Foreign Application Priority Data
Jun. 21, 2016 (DE) 10 2016 111 332.8

(51) Int. Cl. F03D 80/60; F03D 9/25

(52) U.S. Cl. CPC F03D 80/60; F03D 9/25; F05B 2260/20; F05B 2240/2213; F05B 2240/14

(57) ABSTRACT

The invention relates to a wind turbine comprising a tower; a drive train which has a rotor, a rotor bearing, preferably a transmission, and a generator; a cylinder, the longitudinal axis of which extends transversely to the longitudinal axis of the tower and which receives some sections of the drive train on one side; and a dome which closes the other side of the cylinder. The invention is characterized in that the drive train has means for conducting cooling air between the drive train end face opposite the rotor and the lateral surface of the drive train, the cylinder receives an inner cylinder (42) which separates the interior of the cylinder into an outer cylinder intermediate space and an inner cylinder interior, and the dome is designed as an air/air heat exchanger, wherein the inner cylinder is communicatively connected to the drive train end face opposite the rotor and the dome, thereby forming a closed cooling circuit.

The invention relates to a wind turbine with a tower, a power train comprising a rotor, a rotor bearing, if applicable a drive and a generator, in a cylinder extending with its longitudinal axis diagonally to the longitudinal axis of the tower, accommodating sections of the power train on its one side and a dome closing the cylinder on its other side.

Such a wind turbine is known, for example, from U.S. Pat. No. 4,527,072 A, whereby the idea that this construction is based on is to reduce the downtime required for repairs by means of a modular structure and a simple method for fastening the power train components to the tower, which makes them easy to replace.

A disadvantage seems to be the fact, however, that, due to this configuration, the power train of the system cannot be completed until during the final assembly and that it cannot be tested until after the system has been built. Furthermore, this prior art only provides for a passive cooling of the power train, which is insufficient for modern systems.

Usually, wind turbines use a separate construction method, wherein the main components such as the rotor bearing, the drive, the coupling, and the generator are arranged in a series on a mainframe arranged below them. The vertical pivot bearing with drives and brakes are then arranged on the vertical pivot bearing. In directly driven generators without a drive, the mainframe is firmly attached to the generator stator and arranged behind the generator. The additional components such as the greasing system, the cooling and the electrical equipment are then fastened to the mainframe and usually protected from the elements by cladding. One example for this structure is provided in EP 0 821 161 B1.

There are, however, power train structures that integrate the components and that use the housings of the drive and the generator for a load transmission. Here, this power train can be attached to a buffer beam that then transfers the rotor loads to the tower by means of the vertical bearing. One example is described in WO 2008/113 318 A2. Due to the overall compact build, the required cooler elements must be arranged outside the buffer beam and attached to said buffer beam with a bearing structure.

In another arrangement, the drive and the generator are installed in a cast metal housing and designed in a very compact manner. Such a configuration can be seen in EP 0 811 764 B1, for example. The secondary components such as hydraulics, cooling, etc., are separately fastened to the pivot bearing or the nacelle cladding.

This structure therefore requires a significant amount of work and time for its construction, maintenance, and repair, which has a negative effect in particular in offshore wind turbines due to unstable weather conductions and overall difficult working conditions.

The task of the invention is therefore to create a compact wind turbine that is fast and easy to install and maintain, whereby in particular an active cooling system is to be provided for a sufficient removal of heat losses from the power train components.

According to the invention, this task is solved by the wind turbine with the features of claim 1. The subclaims describe advantageous configurations of the invention.

The underlying idea of the invention is to further develop the “removable” part known from the prior art according to U.S. Pat. No. 4,527,072 A so that a functional power train can be inserted into the part provided to accommodate a functional power train, whereby a closed cooling air circuit is created by the combination of the power train and the accommodating part.

The objective of the invention is therefore to design a power train comprising the rotor, rotor bearing, if applicable the drive and generator, that is very compact and lightweight and therefore cost-effective and in which the outer loads are not transmitted by these components, but in which the power train is inserted into a cylinder, for example a bearing steel pipe, as a unit and attached at its front to the rotor bearing, so that the load can then be transferred via this steel pipe to the bearing structure, i.e., the tower.

The drive, if there is one, is affected only slightly and the generator not at all by the external loads.

The connection between the power train unit and the cylinder is preferably created with the fixing screws of the outer rings of the rotor bearing. The front side of the generator is fastened directly to the rear panel lid of the drive or the rotor bearing so that the generator can move freely without any inner loads in the event of deformations of the drive or the rotor gear.

For the remainder of the explanation, it is assumed that the power train comprises a generator, even though the invention may be used for driveless wind turbines as well.

The cylinder may be configured as a simple, cylindrically rolled steel pipe with a flange at its head end toward the rotor bearing connection. Geometrically complicated welding structures made from several sheets or complicated castings with a complicated (re) working are therefore not necessary.

The cylinder may, however, have a differently shaped base such as a rectangle or hexagon. The longitudinal axis of the cylinder is arranged diagonal to the longitudinal axis of the tower; i.e., it may be arranged vertically to the longitudinal axis of the tower or, in particular, deviate between 0° and 30° from the vertical axis to the longitudinal axis.

Furthermore, the generator and the drive are cooled in the wind turbine according to the invention by means of an air/air-heat exchanger cooled with outside air, which is arranged at the end of the cylinder that is opposite the drive train unit. The inner cooling airflow directly absorbs the heat losses from the generator by means of the stator and/or the rotor of the generator through which the air flows. The heat losses from the drive are introduced to this inner airflow as well, preferably by means of an oil/air heat exchanger, either upstream or preferably downstream from the generator. The inner airflow preferably flows first along the outside of the cylinder, i.e., in the space between the inner wall of the cylinder and the outer wall of the inner cylinder, to be able to use the wall of the cylinder for cooling purposes at a high temperature level. Then the air flows through an air/air-plate heat exchanger formed by the dome which is located at the outside in the external airflow.

The cylinder and the inner cylinder are therefore configured as hollow cylinders.

The cylinder and the dome are, in particular, formed as separate elements that are screwed together. It may, in particular, be provided here that the cylinder accommodates a section of the dome such that a tapered dome section is inserted into the cylinder.

Preferably, the entire system is configured as a downwind turbine so that the plate heat exchanger formed by the dome extends against the air flow and is therefore located directly in the supply air of the air flow.

The plate heat exchange consists of thin, preferably stainless-steel sheets which are arranged radially around the inner cylinder, hereinafter also referred to as the “central inner air conduit,” and that are alternately configured either permeably with the inner cylinder or closed to the outer cooling flow. This way, the inner cooling airflow is directed toward the inner cylinder between two sheets. The outer air can sweep between them to conduct the heat from the inside to the outside.

The inner cylinder may, as explained for the cylinder above, deviate from a configuration as a circular cylinder with a circular base and may have a different base shape, for example that of a rectangle or a hexagon.

To be able to transfer the heat losses of approximately 3% of the electrical power, several pairs of metal sheets are required. The overall surface of the cooling sheets depends on the planned output, the efficiency levels, the outside temperature conditions, and the maximum inner temperature allowed.

This cooling unit may be inserted into the cylinder from the outside as an assembly and preferably attached to the cylinder by means of a flange connection. First, however, the inner cylinder with the appropriate airflow and the oil/air cooling systems for cooling the gear oil as well as one or more blowers to circulate the air are installed in the cylinder first.

The entire assembly is particularly preferable if, as is the case in a buoyant wind turbine, for example, no wind supply system is required at the nacelle. In this case, the cylinder may be attached directly to the tower or the bearing structure.

This configuration is not only very lightweight and compact, whereby the outer loads are kept away from the drive and the generator, but it creates a closed-cycle cooling system as well, which is hermetically closed off from the outside air. This is required in particular for offshore systems.

The invention therefore relates to a wind turbine with a tower, a power train comprising a rotor, a rotor bearing, preferably a drive and a generator, in a cylinder extending with its longitudinal axis diagonally to the longitudinal axis of the tower, accommodating sections of the power train on its one side and a dome closing the cylinder on its other side, whereby the power train comprises means for directing the cooling air between its front side opposite the rotor and its lateral area, whereby the cylinder comprises a preferably concentrically arranged inner cylinder, whereby the inside of the cylinder is divided into an outer cylinder space and an inner cylinder space, whereby the dome is configured as an air/air/heat exchanger, and whereby the inner cylinder, forming a closed-cycle cooling system, is attached with the front side of the power train located opposite the rotor and the dome in a communicating manner.

Preferably, the cylinder is rotatably fixed to the tower. In a particularly preferred embodiment, the tower has a lens-shaped to drop-shaped cross-section that supports the supply of wind.

In particular, the cross-sectional area of the inner cylinder corresponds approximately to the cross-sectional area of the cylinder space so that consistent airflow and/or airflow speed is achieved throughout the cooling system.

According to another preferred embodiment, the inner cylinder comprises a section that is conically expanded in the direction of the power train. This section makes it easier to fasten the inner cylinder to the power train, in particular the generator, at whose back further elements requiring cooling such as flow straighteners may be arranged.

It is furthermore preferable that the inner cylinder comprises the front side of the power train located opposite the rotor, i.e., the generator reconversion. To this purpose, it would be preferable if the outer diameter of the generator is smaller than the outer diameter of the drive.

The outer diameter of the drive approximately corresponds to the outer diameter of the cylinder.

The air circulation may be created by the generator's own fan. Particularly preferred is, however, a fan that is arranged in the inner cylinder. Alternatively or additionally, one or more fans may be provided in the cylinder space as well.

Finally, as stated above, it is preferred that the wind energy system is configured as a downwind turbine.

Below, the invention is explained with the help of particularly preferred exemplary embodiments, which are also shown in the attached drawings:

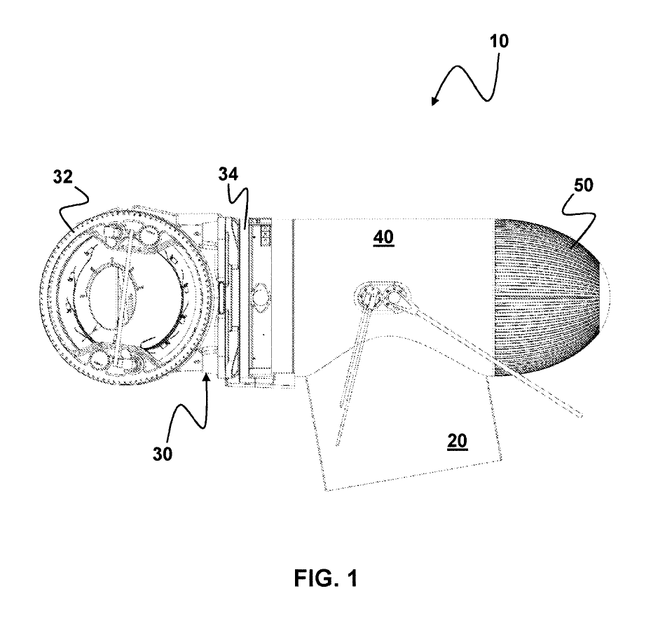

FIG. 1 shows a schematic side view of a wind turbine with a particularly preferred configuration;

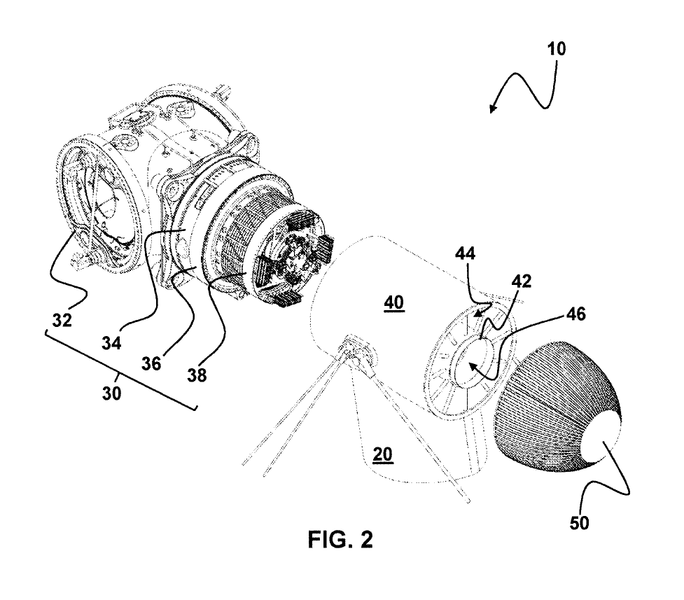

FIG. 2 shows an exploded view of the wind turbine provided in FIG. 1;

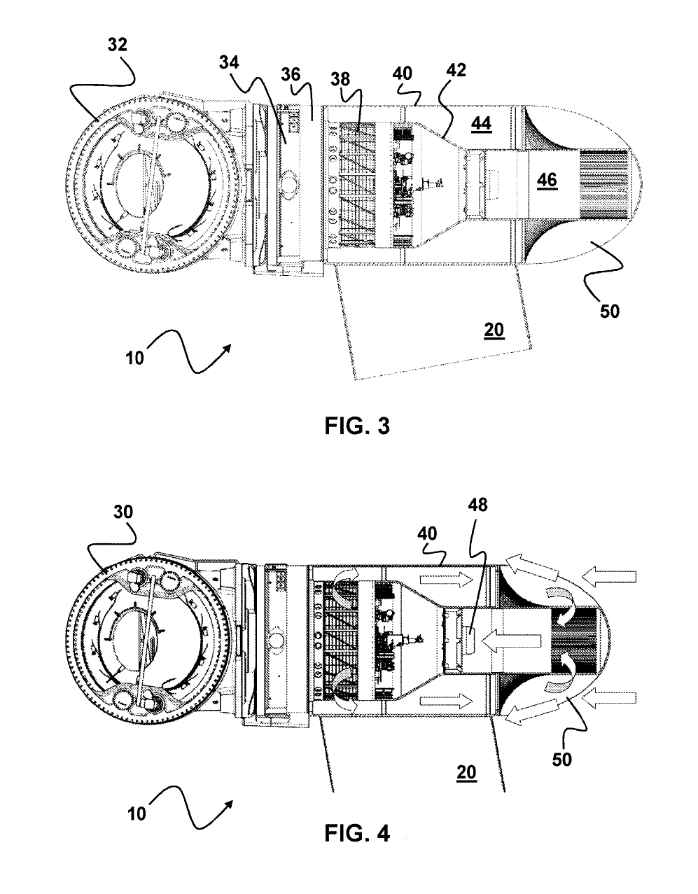

FIG. 3 shows a sectional side view of the wind turbine from FIG. 1;

FIG. 4 shows a sectional side view of the wind turbine from FIG. 1 with schematically displayed airflow;

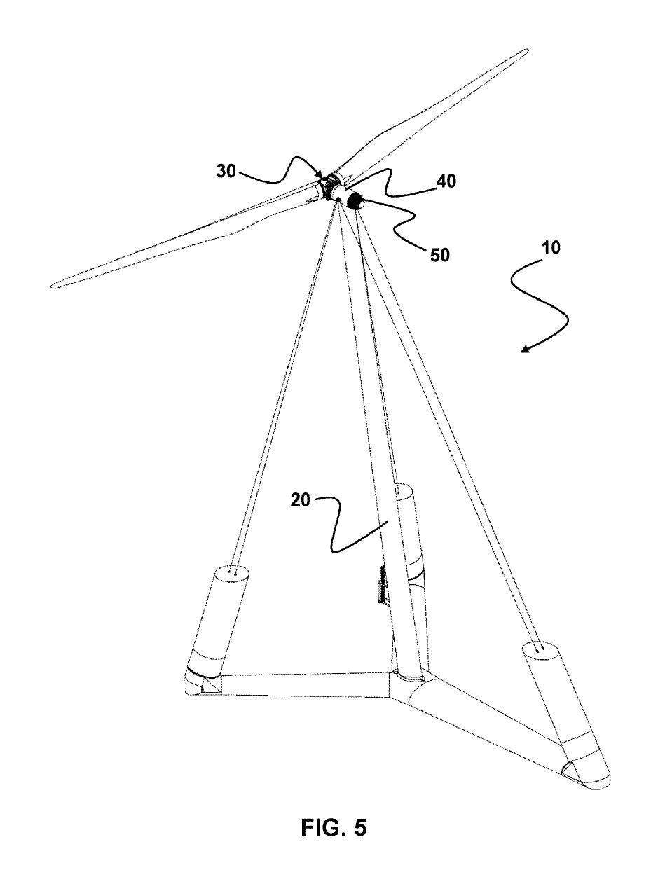

FIG. 5 shows a perspective overall view of a floating offshore wind turbine with a particularly preferred configuration;

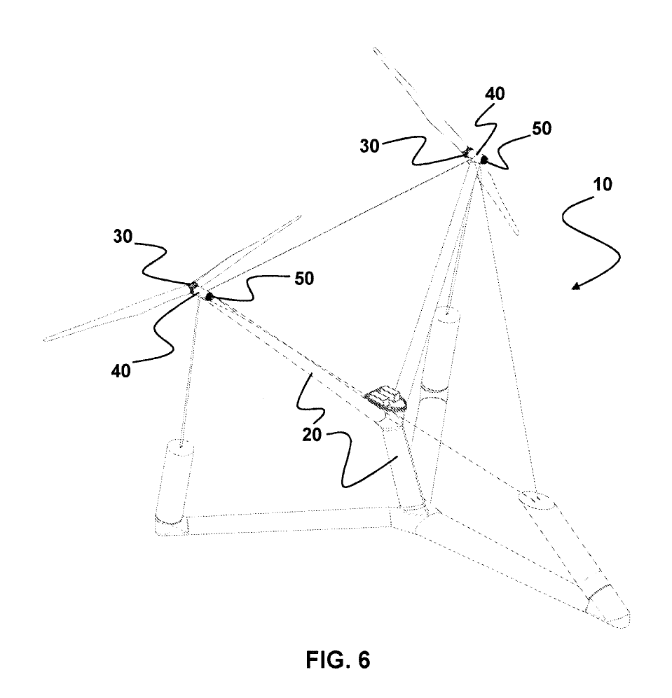

FIG. 6 shows a perspective overall view of a further floating offshore wind turbine with a particularly preferred configuration; and

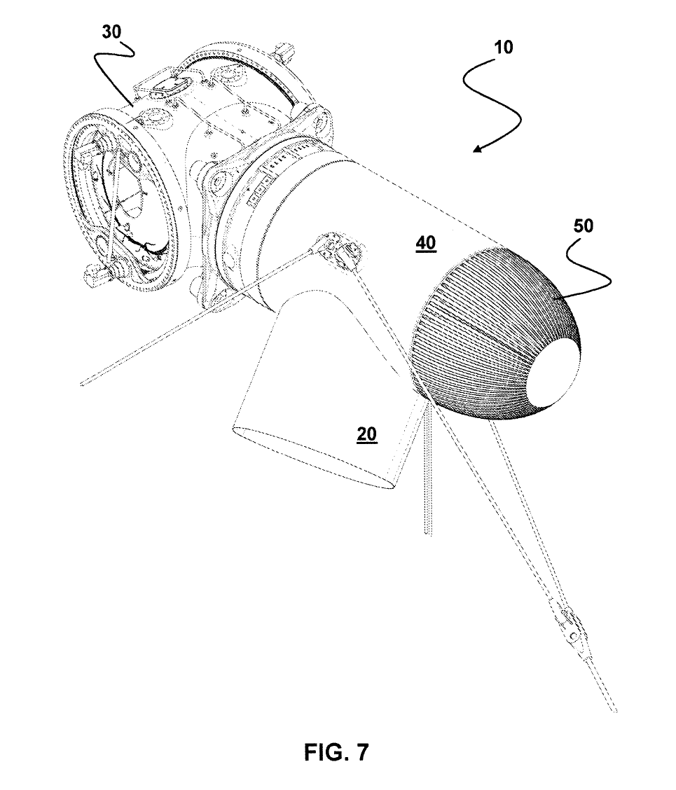

FIG. 7 shows a detailed view of the wind turbine provided in FIG. 6 in the area of the one rotor.

FIG. 1 shows a schematic side view of a wind turbine with a particularly preferred configuration.

The wind turbine 10 comprises a tower 20 with a cylinder 40 arranged on its upper side, which extends with its longitudinal axis diagonally, in this example at an oblique angle of approximately 80° from the longitudinal axis of the tower 20 and which accommodates the power train 30 from where the rotor 32, the rotor bearing 34, and the drive 36 are visible.

On the side opposite the power train 30, a dome 50 that closes the cylinder 40 is provided. It is configured as an air/air-heat exchange, and its outer cooling fins are clearly visible.

The wind turbine shown in FIG. 1 is, in particular, configured as a floating downward wind turbine, whereby the cylinder 40 is firmly attached to the tower 20 which, in turn, is anchored in the floating foundation. To this purpose, it is, in particular, provided that the anchoring is not attached to the tower 20, but the cylinder 40.

FIG. 2 shows an exploded view of the wind turbine provided in FIG. 1.

This illustration clearly shows that a functional and in particular previously tested power train 30 comprising a rotor 32, a rotor bearing 34, a drive 36, and a generator 38 may be inserted on one side of the cylinder 40 as a functional unit, whereby the other side of the cylinder 40 is covered by the dome 50.

Here, the tower 20, the power train 30, the cylinder 40, and the dome 50 are configured so that, when the components are joined, a closed space is created that is not engaged in an exchange of material with the environment.

FIG. 2 shows as well that an inner cylinder 42, which is concentrically arranged to the cylinder 40, is provided in the cylinder 40, which divides the inside of the cylinder 40 into an outer cylinder area 44 and an inner cylinder area 46. The inner cylinder 42 is attached to the cylinder 40 in particular by means of radial support structures that connect the inner wall of the cylinder 40 with the outer wall of the inner cylinder 42.

FIG. 3 shows an opened lateral view of the wind turbine 10 so that the functional interaction between the power train 30, the cylinder 40, in particular the inner cylinder 42, and the dome 50 becomes clear.

The inner cylinder 42 is configured so that the front side of the power train located opposite the rotor 32, i.e., the back wall of the generator 38, is comprised by the one side of the inner cylinder 42 so that the front side of the power train 30 communicates only with the inner cylinder space 46, but not directly with the (outer) cylinder space 44.

On the other side, the inner cylinder 42 is connected to communicate with the conducting structures of the dome 50 configured as an air/air-heat exchanger so that a closed cooling system is created between the power train 30 and the dome 50, which extends from the dome 50 through the inner cylinder space 46 to the power train 30 and from the power train 30 through the cylinder space 44 to the dome 50.

The cooling system is illustrated by the arrows shown in FIG. 4. The inner cooling system is completely closed. At the dome 50, the heat losses are dissipated into the exterior air that passes along the dome 50 as a counterflow.

Finally, FIG. 5 shows a perspective view of a specially configured floating wind turbine 10 with a tower 20 arranged on a floating foundation. On its top side, the tower 20 has a cylinder 40 that is rotatably fixed with the tower 20, whereby the tower 20 is anchored to the foundation by means of suspension points arranged on the cylinder 40.

The floating wind turbine 10 is configured in particular as a downward wind turbine, whereby the tower 20 comprises a cross-section which at least supports the supply of wind.

The power train 30 comprises in the exemplary embodiment shown a two-blade rotor and is, as explained above, accommodated in the cylinder 40, whereby the cylinder 40 is closed by a dome 50 on the side located opposite the power train 30.

FIG. 6 shows another exemplary embodiment of a specially configured floating wind turbine 10 with a tower 20 arranged on a floating foundation. The tower 20 is divided in a vertical section and has two arms branching off from this section in a dichotomous manner. At their ends, a rotatably fixed cylinder 40 is arranged.

Each of these cylinders 40 accommodates one power train 30 so that a floating wind turbine 10 is created that comprises a total of two power trains 30. This approach is preferable in particular for the construction of an overall high-powered turbine in which the individual components have very small dimensions and thus facilitate a better load distribution on the floating foundation.

Finally, FIG. 7 shows a detail of the anchoring in the area of a power train 30. It clearly shows that the suspension ropes are attached to the bracing tube 40 so that a replacement of the power train 30 can be performed without impairing the stability of the floating wind turbine 10 as a whole.

1. Wind turbine with
a tower,
a power train comprising a rotor, a rotor bearing, preferably a drive, and a generator,
a cylinder extending with its longitudinal axis diagonally to the longitudinal axis of the tower, accommodating sections of the power train on the one side of the cylinder, and
a dome closing the cylinder on its other side, wherein
the power train comprises means for providing cooling air between its front side located opposite the rotor and its lateral area,
the cylinder accommodates an inner cylinder which divides the inside of the cylinder into an outer cylinder area and an inner cylinder area,
the dome is configured as an air/air-heat exchanger,
whereby the inner cylinder, forming a closed cooling system, is connected to communicate with the front side of the power train located opposite the rotor and the dome.

2. Wind turbine according to claim 1, wherein the cylinder is rotatably attached to the tower.

3. Wind turbine according to claim 1, wherein the cylinder and the inner cylinder are concentrically arranged with each other.

4. Wind turbine according to claim 1, wherein the cross-section area of the inner cylinder corresponds to the cross-section area of the space.

5. Wind turbine according to claim 1, wherein the inner cylinder has an area that conically widens in the direction of the power train.

6. Wind turbine according to claim 1, wherein the inner cylinder comprises the front side of the power train located opposite the rotor.

7. Wind turbine according to claim 1, wherein the outer diameter of the generator is smaller than the outer diameter of the drive.

8. Wind turbine according to claim 1, wherein the outer diameter of the drive corresponds to the outer diameter of the cylinder.

9. Wind turbine according to claim 1 further comprising a fan arranged in the inner cylinder and/or in the cylinder space.

10. Wind turbine according to claim 1, wherein the wind turbine is configured as a downwind system.
